(19) United States
(12) Patent Application Publication
(10) Pub. No.: US 2026/0164429 A1
(43) Pub. Date: Jun. 11, 2026

(54) LAYER 1 OVERLOADING IN TIME DIVISION DUPLEXING SCENARIOS

(71) Applicant: Dell Products L.P., Round Rock, TX (US)

(72) Inventors: Mohammed Abdelsadek, Kanata (CA); Eran Goldstein, Montreal (CA); Ilya Portnik, Ashton (CA); Jayaram Venguduswamy Srinivasan, Kanata (CA)

(21) Appl. No.: 18/977,050

(22) Filed: Dec. 11, 2024

(51) Int. Cl. H04W 72/1268; H04W 72/54; H04W 72/56

(52) U.S. Cl. CPC H04W 72/1268; H04W 72/54; H04W 72/56

(57) ABSTRACT

A method facilitating Layer 1 overloading in time division duplexing scenarios includes selecting, by a system including at least one processor, a first data unit from among a group of data units received during an uplink time slot based on priority levels assigned by Layer 2 equipment to respective data units, including the first data unit, of the group of data units; performing, by the system, first Layer 1 processing of the first data unit during a first time interval associated with the uplink time slot; and performing, by the system, second Layer 1 processing of a second data unit, of the group of data units and not selected via the selecting, during a second time interval that concludes after conclusion of the first time interval.

### BACKGROUND

In some wireless communication networks, such as those utilizing fifth generation (5G), open radio access network (Open RAN or O-RAN), and/or other network standards, the RAN can be disaggregated into multiple devices, such as a radio unit (RU), distributed unit (DU), and centralized unit (CU). Additionally, some network implementations can utilize a virtualized RAN, in which hardware components are further disaggregated from software to provide enhanced flexibility, e.g., by enabling some network functions to be implemented on commercial off-the-shelf (COTS) hardware. In some virtualized RAN implementations, additional specialized hardware, such as a Layer 1 (L1) accelerator card or the like, can be utilized to supplement the functionality of this COTS hardware.

### SUMMARY

The following summary is a general overview of various embodiments disclosed herein and is not intended to be exhaustive or limiting upon the disclosed embodiments. Embodiments are better understood upon consideration of the detailed description below in conjunction with the accompanying drawings and claims.

In an implementation, a system is described herein. The system can include at least one processor and at least one memory that stores executable instructions that, when executed by the at least one processor, facilitate performance of operations. The operations can include selecting a first data packet from among a group of data packets received during an uplink time slot based on priority indicators assigned by Layer 2 equipment to respective data packets, including the first data packet, of the group of data packets. The operations can further include performing first Layer 1 processing of the first data packet during a first time window relative to the uplink time slot. The operations can additionally include performing second Layer 1 processing of a second data packet, of the group of data packets and not selected via the selecting, during a second time window that concludes after conclusion of the first time window.

In another implementation, a method is described herein. The method can include selecting, by a system including at least one processor, a first data unit from among a group of data units received during an uplink time slot based on priority levels assigned by Layer 2 equipment to respective data units, including the first data unit, of the group of data units. The method can also include performing, by the system, first Layer 1 processing of the first data unit during a first time interval associated with the uplink time slot. The method can further include performing, by the system, second Layer 1 processing of a second data unit, of the group of data units and not selected via the selecting, during a second time interval that concludes after conclusion of the first time interval.

In an additional implementation, a non-transitory machine-readable medium is described herein that can include instructions that, when executed by at least one processor, facilitate performance of operations. The operations can include selecting a first data packet from among a group of data packets received during an uplink time slot based on priority information received from Layer 2 equipment, the priority information being associated with respective data packets, including the first data packet, of the group of data packets; performing first Layer 1 processing of the first data packet during a first time interval associated with the uplink time slot; and performing second Layer 1 processing of a second data packet, of the group of data packets and not selected via the selecting, during a second time interval that extends beyond a time of conclusion of the first time interval.

### DESCRIPTION OF DRAWINGS

Various non-limiting embodiments of the subject disclosure are described with reference to the following figures, wherein like reference numerals refer to like parts throughout unless otherwise specified.

FIG. 1 is a block diagram of a system that facilitates Layer 1 (L1) overloading in time division duplexing (TDD) scenarios in accordance with various implementations described herein.

FIGS. 2-4 are block diagrams of respective example split network architectures in which various implementations described herein can function.

FIGS. 5-6 are timing diagrams representing example operations that can be performed via various implementations described herein.

FIG. 7 is a block diagram of another system that facilitates L1 overloading in TDD scenarios in accordance with various implementations described herein.

FIG. 8 is a messaging flow diagram that illustrates example interactions between L1 equipment and Layer 2 (L2) equipment in accordance with various implementations described herein.

FIG. 9 is another timing diagram representing example operations that can be performed via various implementations described herein.

FIG. 10 is a block diagram of an additional system that facilitates L1 overloading in TDD scenarios in accordance with various implementations described herein.

FIGS. 11A-11B and 12A-12B are additional timing diagrams representing example operations that can be performed via various implementations described herein.

FIGS. 13-14 are flow diagrams of respective methods that facilitate L1 overloading in TDD scenarios in accordance with various implementations described herein.

FIG. 15 is a diagram of an example computing environment in which various implementations described herein can function.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring subject matter.

Implementations described herein can enhance the performance of wireless network equipment, such as distributed unit (DU) equipment in a split radio access network (RAN) architecture, in time division duplexing (TDD) systems by facilitating overloading of Layer 1 (L1) processing tasks. For example, as will be described in further detail herein, L1 processing equipment can leverage disparities in processing loads associated with uplink (UL) and downlink (DL) slots to improve overall L1 processing efficiency and mitigate underutilization of L1 processing resources that can occur in conventional systems. In doing so, improvements to the performance of RAN equipment can be realized by increasing the number of cells that can be supported by L1 hardware, increasing overall UL network throughput, enabling the use of more computationally complex network features that can improve user equipment (UE) range and/or service, or the like. Other improvements to network and/or network device performance are also possible.

With regard to the following description, it is noted that any references to specific network components, standards, technologies, or the like, are made merely by way of example and are not intended to limit the scope of the description or the claimed subject matter unless explicitly stated otherwise. For instance, while various examples provided herein relate to examples involving fifth generation (5G) new radio (NR) networks, Open RAN (O-RAN) network architectures, or the like, it is noted that similar concepts to those described herein could also be applied to other network types and/or architectures, either in addition to or in place of the named network types and/or architectures.

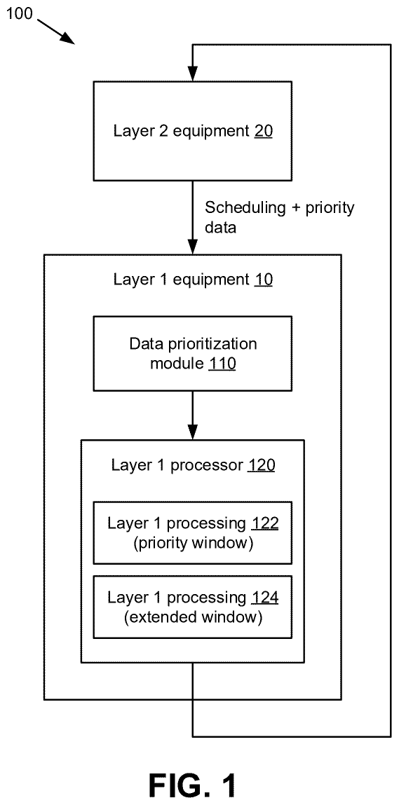

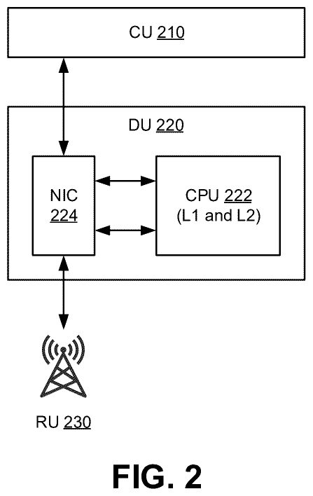

With reference now to the drawings, FIG. 1 illustrates a block diagram of a system 100 that facilitates L1 overloading in TDD scenarios in accordance with various implementations described herein. System 100 as shown in FIG. 1 includes L1 equipment 10 and Layer 2 (L2) equipment 20, which can be implemented via a single network equipment device and/or divided among multiple network equipment devices. Example architectures that can be utilized to implement the L1 equipment 10 and L2 equipment 20 shown in system 100 are described in further detail below with respect to FIGS. 2-4.

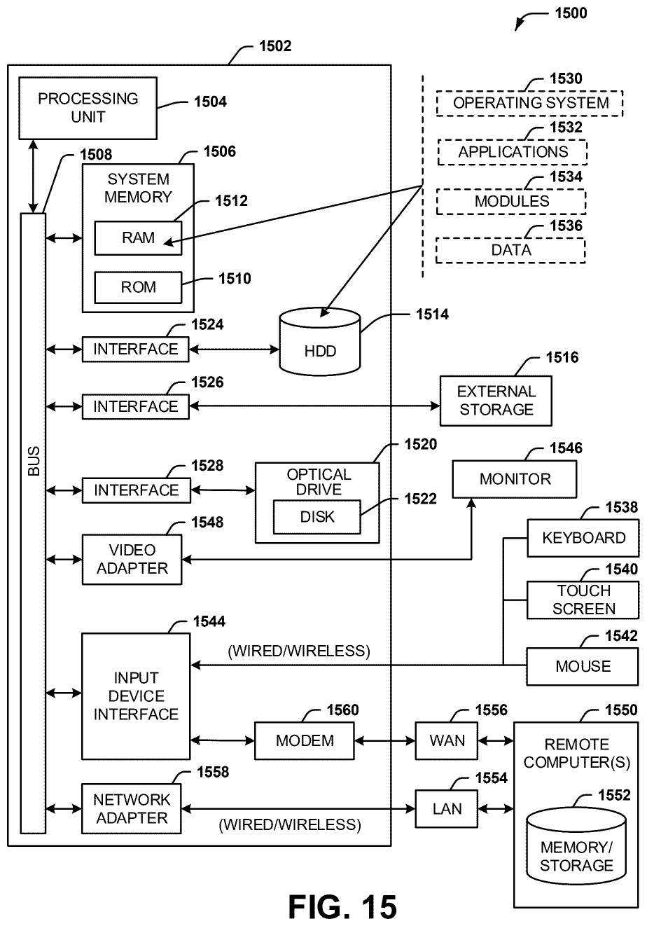

The L1 equipment 10 shown in FIG. 1 includes executable components, e.g., a data prioritization module 110 and an L1 processor 120, which can operate as described in further detail below. In an implementation, the components 110, 120 of system 100 can be implemented in hardware, software, or a combination of hardware and software. By way of example, the data prioritization module 110 can be stored on at least one memory and executed by at least one processor (e.g., a general purpose processor, the L1 processor 120, etc.). The L1 processor 120 can include one or more physical processors (e.g., central processing units (CPUs), L1 accelerator cards or other hardware, etc.), which can implement machine-executable instructions to perform one or more operations, such as operations facilitating L1 processing 122, 124 in different time intervals or windows as described below. Instructions facilitating the L1 processing 122, 124 can be stored on a memory and/or another suitable non-transitory machine-readable medium. An example of a computer architecture including a processor and memory that can be used to implement the components 110, 120, as well as other components as will be described herein, is shown and described in further detail below with respect to FIG. 15. In some implementations, the executable components 110, 120 of system 100, and/or other elements of system 100, can communicate with each other via a bus and/or other components that provide intercommunication between various elements of system 100.

It is noted that the functionality of the respective components shown and described herein can be implemented via a single computing device and/or a combination of devices. For instance, in various implementations, the data prioritization module 110 shown in FIG. 1 could be implemented via a first device, and the L1 processor 120 could be implemented via the first device or a second device. Also, or alternatively, the functionality of a single component could be divided among multiple devices in some implementations.

As will be described in further detail below, the L1 equipment 10 and L2 equipment 20 of system 100 can be implemented as part of network equipment devices (e.g., base station equipment, Node B equipment, etc.) associated with a RAN or other suitable communication network. Alternatively, one or more devices implementing system 100 could be separate from said devices and communicate with associated network equipment through any suitable wired and/or wireless communication technology(-ies).

With reference now to the components of system 100, the data prioritization module 110 can select a first data packet (e.g., a protocol data unit (PDU) or other data unit) from among a group of data packets received during an UL time slot based on priority indicators that are assigned by the L2 equipment 20 to respective ones of the group of data packets. In an implementation, the L2 equipment 20 can send priority indicators associated with respective data packets as part of scheduling information associated with those data packets, e.g., by expanding the scheduling information to include an additional field for the priority indicators. In another implementation, the L2 equipment 20 can provide priority information to the L1 equipment 10 separately from scheduling information.

Based on the data prioritization module 110 selecting one or more data packets based on priority information received from the L2 equipment 20, the L1 processor 120 can perform one or more processing operations, such as decoding, equalization, and/or other operations, during a priority L1 processing window (interval) 122 or an extended L1 processing window (interval) 124. For example, the L1 processor 120 can perform first L1 processing of the first data packet selected by the data prioritization module 110 based on its priority information in a first time window (e.g., the priority window 122 shown in FIG. 1) relative to the UL time slot during which the first data packet was received. The L1 processor 120 can then perform second L1 processing of a second data packet, of the group of data packets received during the UL time slot and not selected by the data prioritization module 110, during a second time window (e.g., the extended window 124 shown in FIG. 1) that concludes after conclusion of the first time window, e.g., such that the second time window extends beyond a time of conclusion of the first time window.

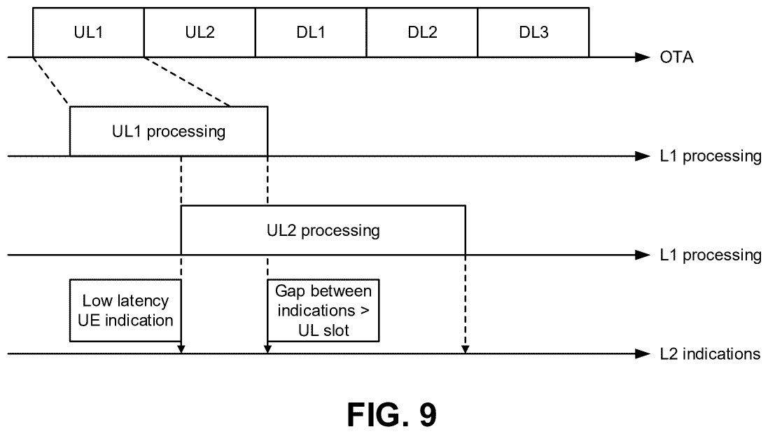

The priority window 122 and the extended window 124 shown in FIG. 1 can be utilized for L1 processing of respective PDUs or other data packets based on their priority, e.g., such that the priority window 122 and the extended window 124 can be used to process high-priority PDUs and low-priority PDUs, respectively. In various implementations, the priority window 122 and the extended window 124 can be configured to occur at least partially in parallel, e.g., such that the priority window 122 and the extended window 124 start at the same time and/or otherwise at least partially overlap in time. In other implementations, the priority window 122 and the extended window 124 can occur serially, e.g., such that the extended window 124 begins once the priority window 122 has concluded. In general, because the extended window 124 facilitates L1 processing of lower-priority data over a longer time interval than that of the priority window 122, the extended window 124 can be configured to conclude after conclusion of the priority window 122. An example of the interaction between these time windows is described in further detail below with respect to FIG. 9.

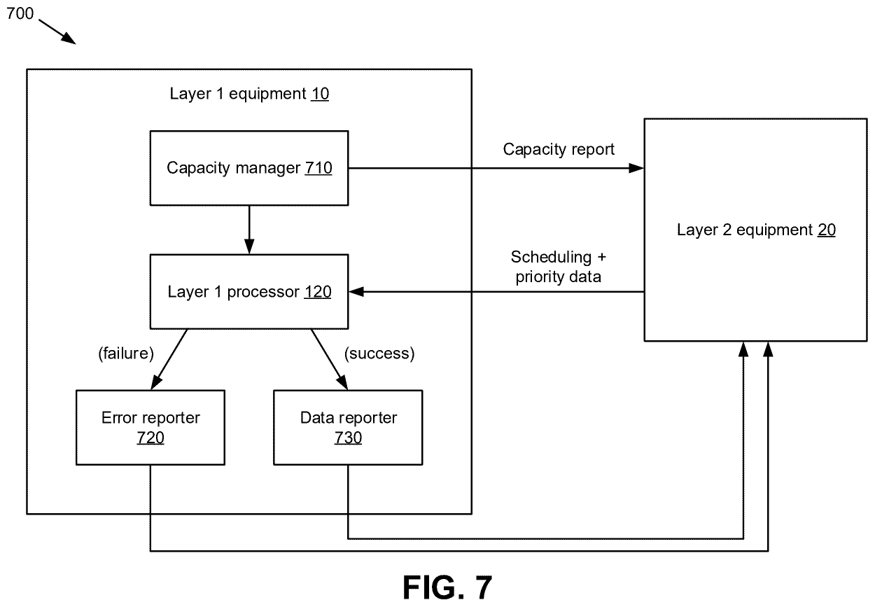

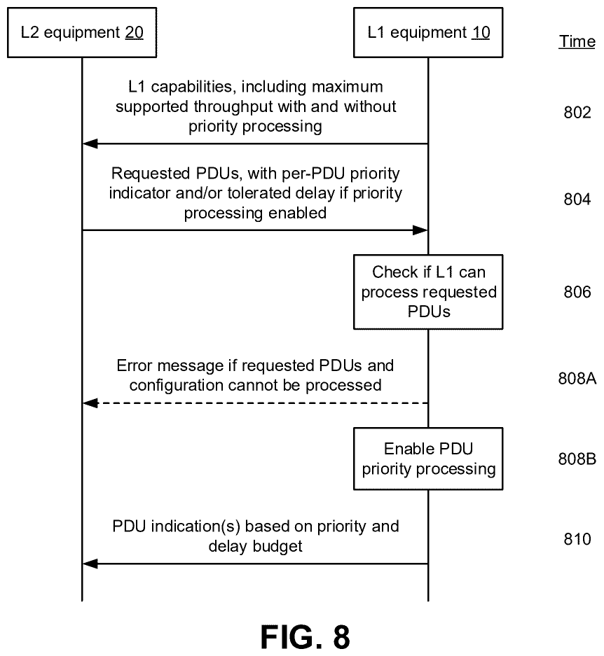

In an implementation, priority data provided to the L1 equipment 10 by the L2 equipment can indicate a tolerance of respective data packets to processing delay. For instance, the priority information can relate to quality of service (QOS) classes with which respective received data packets belong, based on which the data prioritization module 110 can prioritize one or more received data packets for processing during the priority window 122 and/or extended window 124 based on the relative delay tolerances of the identified QoS classes. In another implementation, the priority data provided by the L2 equipment 20 can include binary values or other indicators that directly assign respective packets to the priority window 122 or the extended window 124. Scheduling and priority information that can be provided to the L1 equipment 10 by the L2 equipment in this manner, as well as operations that can be performed by the L1 equipment 10 in response to such information, are described in further detail below with respect to FIGS. 7-8.

Turning next to FIGS. 2-4, various split RAN architectures in which implementations described herein can function are illustrated. As noted above, in 5G and O-RAN networks, functionality of a Node B (e.g., a next-generation Node B or gNB) and/or other RAN equipment can be split among multiple physical devices. As shown in FIG. 2, these devices can include a centralized unit (CU) 210, a distributed unit (DU) 220, and a radio unit (RU) 230. In a split architecture such as that shown by FIG. 2, network functions can be divided such that, e.g., the RU 230 performs radio frequency (RF) processing and/or related tasks, the DU 220 performs L1 and L2 processing functions, and the CU 210 performs Layer 3 (L3) and/or other functions. In some implementations, some L2 processing functions can also be split between the CU 210 and the DU 220. In an implementation in which both the CU 210 and DU 220 perform L2 functions, L2 functions performed by the CU 210 can be referred to as “upper” L2 functions, and L2 functions performed by the DU 220 can be referred to as “lower” L2 functions.

In the example architecture shown by FIG. 2, a virtualized RAN is implemented, in which L1 and L2 functions are performed in software via commercial off-the-shelf (COTS) hardware such as a general-purpose CPU 222. As shown in FIG. 2, the DU 220 can interact with the CU 210 and/or RU 230 via a network interface card (NIC) 224, which can communicate with the CPU 222 of the DU 220 to facilitate software-driven L1 and/or L2 processing.

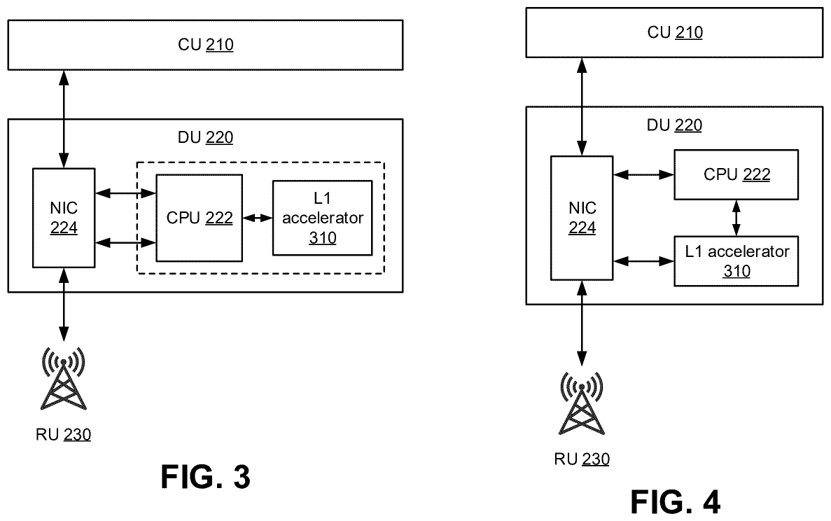

As shown in FIG. 2, a general purpose CPU 222 provides all L1 and L2 processing functionality of the DU 220. However, general purpose COTS processors have limitations in performing L1 and L2 processing tasks due to the demands of the high-speed and low-latency processing associated with these functions in a 5G RAN. Accordingly, as shown in FIGS. 3-4, additional specialized hardware, such as an L1 accelerator card 310 or the like, can be introduced to mitigate the limitations of COTS hardware by offloading part of all of the L1 functions from the CPU 222 in order to improve the performance of the DU 220.

FIGS. 3-4 illustrate two different categories of L1 accelerator architectures. FIG. 3 illustrates a lookaside architecture, in which L1 accelerator hardware, such as an L1 accelerator card 310 as shown in FIG. 3 and/or additional hardware integrated into the main CPU 222, is utilized to offload select L1 functions (e.g., forward error correction or FEC, etc.) from the CPU 222. Thus, in the lookaside architecture shown in FIG. 3, the majority of L1 processing functions continue to be performed by the CPU 222. On the other hand, FIG. 4 illustrates an inline architecture, in which all L1 processing is offloaded from the CPU 222 to the L1 accelerator card 310. As shown in FIG. 4, an L1 accelerator card 310 can directly communicate with the CU 210 and RU 230 via the NIC 224 of the DU 220 to perform all L1 functionality without assistance from the CPU 222.

Regardless of the specific L1 processing architecture utilized by the DU 220, L2 functions generally expect L1 to finish decoding in a real-time manner. Stated another way, it is desirable for the time taken by L1 processing to be shorter than a slot (e.g., 0.5 ms for 30 kHz subcarrier spacing). While this is generally not an issue for DL L1 processing, UL L1 processing tends to be more demanding on the L1 hardware since it requires more functions, such as channel estimation, equalization, and the like. As a result, the performance of the DU 220 is generally limited by its ability to perform UL L1 processing, even in architectures in which L1 accelerator hardware is used. This further results in UL L1 processing creating a bottleneck in cell capacity, especially in environments with large bandwidth, large numbers of users, and/or high numbers of antennas. Additionally, because L1 hardware is often not designed for a single use case, some types of L1 hardware could be underutilized in some scenarios unless modifications are made.

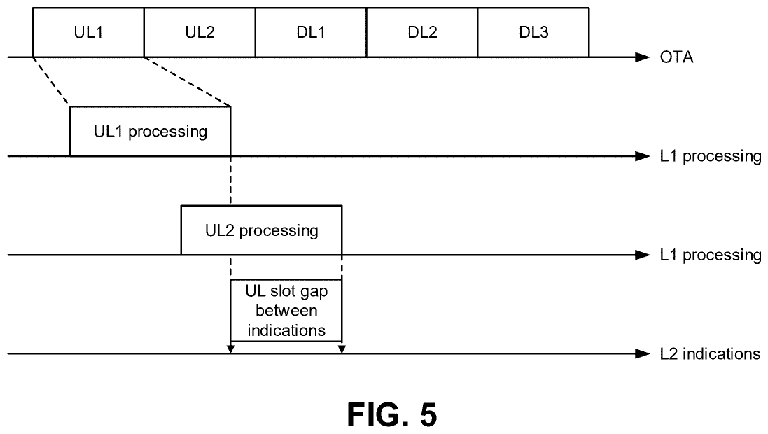

Moreover, in TDD cellular networks, a predefined slot pattern can be utilized, such that some slots are used for UL transmission and other slots are used for DL transmission. An example TDD slot pattern is shown in FIG. 5, where an over the air (OTA) slot pattern can consist of two UL slots, shown in FIG. 5 as slots UL1 and UL2, followed by three DL slots, shown in FIG. 5 as DL1, DL2, and DL3. It is noted that the slot pattern shown in FIG. 5 is provided merely by way of non-limiting example and that other slot patterns could also be used. As shown by FIG. 5, data received in UL slots UL1 and UL2 can be processed by L1 equipment in a time window following the respective slots, and at the conclusion of each processing window the L1 equipment can provide indications of the processed data to L2 equipment. In the example shown by FIG. 5, L1 processing corresponding to each UL slot occurs in a fixed time interval. Thus, there is a gap equal to the length of one UL slot between the L2 indications corresponding to slots UL1 and UL2.

However, restricting all UL processing to a fixed time interval strictly corresponding to the UL slot length can result in degraded L1 equipment performance due to, e.g., the imbalance between UL and DL processing loads on the L1 hardware (e.g., a CPU 222 and/or L1 accelerator card 310, as described above with respect to FIGS. 2-4). More particularly, due to the extra processing tasks (e.g., channel estimation, equalization, etc.) needed when receiving UL data to account for the channel over which the UL data is received, utilization of L1 hardware can become very high when processing UL slots but significantly lessen when processing DL slots.

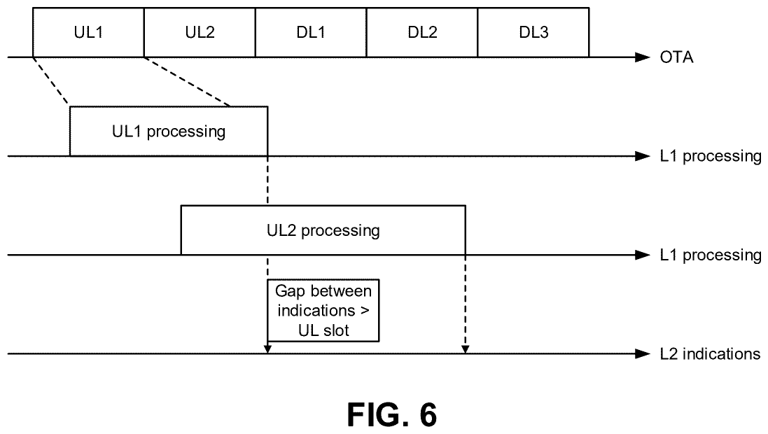

To address the underutilization of L1 processing in TDD systems as described above, implementations described herein can facilitate extension of UL slot processing into an extended processing window that follows a standard processing window associated with an UL slot. An example of extended L1 processing windows that can be used in this manner is shown in FIG. 6. As FIG. 6 illustrates, L1 processing operations associated with an UL time slot can be extended by a given amount, e.g., as defined by a second time interval relative to a first time interval as shown by FIG. 5. As additionally shown in FIG. 6, the amount of time by which the L1 processing window for a given UL slot can be extended can be based on whether an UL slot or a DL slot follows the UL slot to be processed. Thus, for instance, the L1 processing interval for slot UL1 as shown in FIG. 6 can be extended by a first length based on a second uplink slot UL2 following slot UL1. Conversely, the L1 processing interval for slot UL2 as shown in FIG. 6 can be extended by a second, longer length based on a DL slot DL1 following slot UL2. As a result of this disparity in the lengths of the processing windows for slots UL1 and UL2, the gap between the indications provided to L2 equipment resulting from processing slots UL1 and UL2 can be larger than the length of an UL slot.

As a result of utilizing extended L1 processing intervals as shown by FIG. 6, L1 hardware can take advantage of the lower processing requirements during DL slots in order to continue processing UL slots. This can have a cascading effect, such that even in the case as shown in FIG. 6 where multiple UL slots occur in sequence, extending L1 processing for later UL slots can enable some extension of the L1 processing interval for earlier UL slots as well due to lower average processing loads over the length of the extended L1 processing intervals.

By leveraging the lower processing requirements during DL slots, multiple forms of gain can be achieved via the extra processing power that becomes available during less processor-intensive periods in a TDD configuration (e.g., DL slots, etc.) at the cost of higher UL processing latency for some slots. This gain can include, but is not necessarily limited to, the following:
1) The number of cells that can be supported by L1 hardware, e.g., L1 hardware associated with a DU, can be increased, as L1 hardware can often be used to support several cells.
2) UL throughput can be increased in scenarios in which the L1 hardware is limited in UL throughput.
3) Additional, more computationally complex UL features for signal reception can be used, such as various turbo equalization techniques or the like, to improve the range and/or service for UEs that communicate with the L1 hardware.

Other types of gain could also be realized. In general, by spreading out UL processing over a larger time window, various implementations as described herein can facilitate overloading L1 hardware, e.g., to provide enhanced throughput and capacity (e.g., by enabling a DU to handle more cells, more users, more advanced processing algorithms, etc.) in exchange for reduced latency performance for some UL data.

With reference now to FIG. 7, a block diagram of another system 700 that facilitates L1 overloading in TDD scenarios in accordance with various implementations described herein are provided. Repetitive description of like parts described above with regard to other implementations is omitted for brevity. System 700 as shown in FIG. 7 includes L1 equipment 10, which can communicate with L2 equipment 20 to facilitate processing data transmitted and/or received via a communication network in a similar manner to that described above with respect to FIG. 1. The L1 equipment 10 shown in system 700 includes a capacity manager 710, which can determine a throughput capacity of the L1 equipment 10 for performing L1 data processing in a priority time window and an extended time window (e.g., the priority time window 122 and the extended time window 124 described above with respect to FIG. 1). Based on this determination, the capacity manager 710 can send capacity information, representative of the throughput capacity of the L1 equipment 10 in the respective time windows, to the L2 equipment 20.

In response to receiving the capacity information, the L2 equipment 20 can then assign priority indicators to respective PDUs and/or other data units to be provided to the L1 equipment 10 for processing. The L2 equipment 20 can then provide these priority indicators along with scheduling information and/or other information associated with the data units to be processed, e.g., as described above with respect to FIG. 1. This information as sent by the L2 equipment 20 can be received at the L1 equipment 10 by an L1 processor 120, which can be implemented via a CPU 222 and/or an L1 accelerator card 310 as described above with respect to FIGS. 2-4, and/or by other suitable components of the L1 equipment 10. In response to receiving the scheduling and priority information from the L2 equipment 20, the L1 equipment 10 can select, e.g., via a data prioritization module 110 (not shown in FIG. 7) as described above with respect to FIG. 1, respective data units for processing during a priority processing window and an extended processing window that follows the priority processing window.

In addition, the L1 processor 120 can determine a number of data units (packets, PDUs, etc.) that are to be processed in the priority window, e.g., based on the scheduling information provided by the L2 equipment 20. In the event that the number of data units scheduled for L1 processing during the priority processing window exceeds the throughput capacity of the L1 processor 120 for that time window, the L1 equipment 10 can send an error message to the L2 equipment 20 via an error reporter 720 as shown in FIG. 7. In response to the L1 equipment 10 sending an error message to the L2 equipment 20, the L1 equipment 10 and L2 equipment 20 can utilize one or more techniques as known in the art for handling an L1 processing error. Alternatively, if the number of data units scheduled during the priority processing window does not exceed the capacity of the L1 processor 120, the L1 processor 120 can process the data as scheduled and provide corresponding L2 indications to the L2 equipment 20 via a data reporter 730 as further shown in FIG. 7.

Turning now to FIG. 8, and with further reference to FIG. 7, example operations that can be performed by L1 equipment 10 and L2 equipment 20 are shown. The operations shown at FIG. 8 can begin at time 802, at which the L1 equipment 10 can indicate its capabilities to the L2 equipment 20, including a maximum supported throughput with and without priority processing. In some implementations, the L1 equipment 10 can provide this capability information to the L2 equipment 20 as an offline process, e.g., during initial device setup or configuration and/or at another suitable time. In other implementations, the L1 equipment 10 can provide capability information during runtime, e.g., at regular intervals and/or in response to a request from the L2 equipment 20 to provide such information.

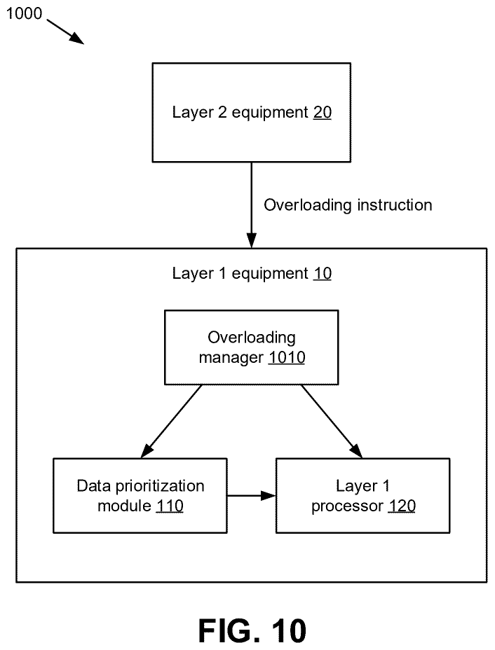

At time 804, the L2 equipment 20 can provide one or more requested PDUs or other data packets to the L1 equipment 10. If priority processing is enabled at the L1 equipment 10, the L2 equipment 20 can additionally provide the L1 equipment 10 with per-PDU priority indicators and/or tolerated delay information along with the PDUs. Techniques that can be utilized to enable and/or disable priority processing at the L1 equipment 10 are described in further detail below with respect to FIG. 10.

Next, at time 806, the L1 equipment 10 can check if the requested PDUs sent by the L2 equipment at time 804 can be processed in the time window allotted for their processing. If priority processing is enabled at the L1 equipment 10, the L1 equipment 10 can make this determination based on the capacity of the L1 equipment 10 for processing PDUs in both a priority time window and an extended time window, e.g., as described above.

If the L1 equipment 10 determines at time 806 that the scheduling provided by the L2 equipment 20 at time 804 is beyond its capabilities, the L1 equipment 10 can send an error message to the L2 equipment, e.g., as indicated at time 808A. Otherwise, the L1 equipment 10 can enable PDU priority processing as indicated at time 808B, e.g., such that the L1 equipment 10 can decode and/or otherwise process higher-priority PDUs first and then lower-priority PDUs after the higher-priority PDUs. As the L1 equipment 10 processes the PDUs, it can send PDU indications back to the L2 equipment as appropriate as indicated at time 810. Additional details regarding techniques that can be utilized by the L1 equipment 10 for providing prioritized L2 indications are provided below with respect to FIG. 9.

Returning now to FIG. 7, the L2 equipment 20 can provide priority data to the L1 equipment 10 in order to meet QoS requirements for delay-sensitive packets while still enabling the standard processing window of the L1 equipment 10 to be extended for non-delay-sensitive packets. For instance, some TDD slots can have users with delay-sensitive data where the total processing latency must remain under specified limits. This can particularly be the case for ultra-reliable and low-latency (URLLC) communications and/or other types of time-sensitive communications. Accordingly, the L2 equipment 20 can instruct the L1 equipment 10 to not apply delayed processing to all packets, but instead to apply delayed processing to only packets that have comparatively more delay tolerance. This can enable delay-intolerant packets to be processed with priority, e.g., in the time window conventionally allocated to L1 processing, such that indications for those packets can be provided within the space of a single time slot.

The above principle is further illustrated by FIG. 9. As shown in FIG. 9, L1 processing for PDUs and/or other packets received during slot UL1 that are designated by L2 equipment 20 as delay intolerant can be performed first, e.g., during a priority time interval at the beginning of the L1 processing window for slot UL1. As further shown by FIG. 9, the L1 equipment 10 can then provide processed data (e.g., L2 indications) corresponding to the delay-intolerant and/or otherwise high-priority packets to the L2 equipment 20 prior to processing delay-tolerant packets. For instance, the L1 equipment 10 can transmit L2 indications corresponding to high-priority data received during slot UL1 upon conclusion of the time window allocated for processing that data and/or upon completing L1 processing for that data. These indications are denoted in FIG. 9 as low latency UE indications. Subsequently, at the conclusion of the extended processing window for slot UL1, the L1 equipment 10 can provide indications corresponding to the remainder of the packets received during slot UL1, i.e., packets designated as lower priority or less delay sensitive. In this way, higher-priority data received during a given UL slot can be processed and sent to upper layers by L1 in a similar manner to conventional L1 processing while still enabling L1 overloading for lower-priority data.

Returning again to FIG. 7, the L2 equipment 20 of system 700 can be configured, e.g., through the use of a new timer and/or other mechanisms, to accept some L1 UL indications at a higher latency per slot than other indications, e.g., as noted above with respect to FIG. 9. In an implementation, the L2 equipment 20 can set a timeframe for receiving L1 indications for respective PDUs or other data packets based on the priority values assigned to those PDUs, e.g., such that indications for PDUs designated by the L2 equipment 20 as high priority are expected before indications for other PDUs designated by the L2 equipment 20 as low priority.

In an implementation, the communications shown in FIG. 7 between the L1 equipment 10 and L2 equipment 20 can be performed via an L1-L2 application programming interface (API) that facilitates L1-L2 communications. Such an API could enable the L2 equipment 20 to communicate detailed priority information to the L1 equipment 10. For instance, depending on priority, the L2 equipment 20 could prioritize UEs from some cells over UEs from other cells, e.g., to reduce latency associated with the prioritized cells. Additionally, the L2 equipment 20 can consider the impact on QoS requirements of respective users and prioritize L1 processing to avoid degradation.

In a typical network implementation, a cell can serve many UEs, each of which may have their own QoS requirements. One of these QoS requirements is the delay budget, which can be defined per QoS level (e.g., as denoted via a 5G QoS identifier or 5QI value) and specified by relevant 5G standards. Examples of 5QI classes, their corresponding packet delay budgets, and example services are provided in Table 1 below. It is noted that Table 1 is provided merely by way of example and is not intended to be an exhaustive listing of possible 5QI values or corresponding QoS properties.

TABLE 1
Example 5QI/delay budget relationships
and corresponding services.

| 5QI | Packet Delay | |
|---|---|---|
| Value | Budget | Example Services |
| 1 | 100 ms | Conversational voice |
| 2 | 150 ms | Conversational video (live streaming) |
| 3 | 50 ms | Real time gaming, vehicle-to-everything (V2X), |
| | | electricity distribution, process automation |
| 4 | 300 ms | Non-conversational video (buffered streaming) |
| 65 | 75 ms | Mission-critical user plane push to talk voice |
| 66 | 100 ms | Non-mission-critical user plane push to talk voice |
| 67 | 100 ms | Mission-critical video user plane |

It is noted with respect to Table 1 that L1 processing latency makes up only a portion of the total delay budget of a given user, which can include other components from other layers and blocks. Thus, for some QoS levels, particularly those with a low total packet delay budgets (e.g., less than 100 ms), the delay budgets of those QoS levels can necessitate the L1 equipment 10 to decode corresponding UL transmissions with a shorter delay. However, as can be further seen in Table 1, several QoS levels can be tolerant of additional latency, particularly those with higher total packet delay budgets (e.g., greater than or equal to 100 ms). For these QoS classes, an additional latency of a few slots, which can accumulate to around 1 ms depending on the grid numerology, can be tolerated without risking exceeding the latency budget for those users.

In a typical network environment, URLLC and other low-latency-tolerant QoS classes make up a comparatively small portion of overall network traffic. Accordingly, significant gains to L1 processing capacity can be made in most network environments via L1 overloading as described herein while still meeting relevant QoS requirements. For the portion of traffic that is not tolerant to additional L1 processing delay, the L2 equipment 20 can indicate this to the L1 equipment 10, e.g., via setting a priority bit in a scheduling message, indicating the 5QI value or other QoS class of the traffic, and/or by other means, to enable the L1 equipment 10 to process this data before other, lower-priority data.

Turning next to FIG. 10, a block diagram of another system 1000 that facilitates L1 overloading in TDD scenarios is illustrated. Repetitive description of like parts described above with regard to other implementations is omitted for brevity. As shown in FIG. 10, the L1 equipment 10 of system 1000 can receive, e.g., via an overloading manager 1010, an instruction from L2 equipment 20 to enable priority processing of data packets, e.g., via the priority window 122 and the extended window 124 described above with respect to FIG. 1. In response to receiving such an instruction, the overloading manager 1010 can facilitate operation of other components of the L1 equipment 10, such as the data prioritization module 110 and L1 processor 120 described above with respect to FIG. 1, to process incoming UL data according to priority information provided by the L2 equipment 20 along with the UL data.

In an implementation, L1 overloading can be enabled and/or disabled by the L2 equipment 20 based on the capabilities of the L1 equipment 10, current traffic volume and/or characteristics, and/or other factors. For instance, the L2 equipment 20 can enable L1 overloading in response to receiving an indication (e.g., via a capacity manager 710 as described above with respect to FIG. 7) that the L1 equipment 10 is capable of priority processing. The L2 equipment 20 can subsequently enable and/or disable priority processing, e.g., on an as-needed basis based on the amount of UL traffic received, the delay tolerance of received UL data, and/or other factors.

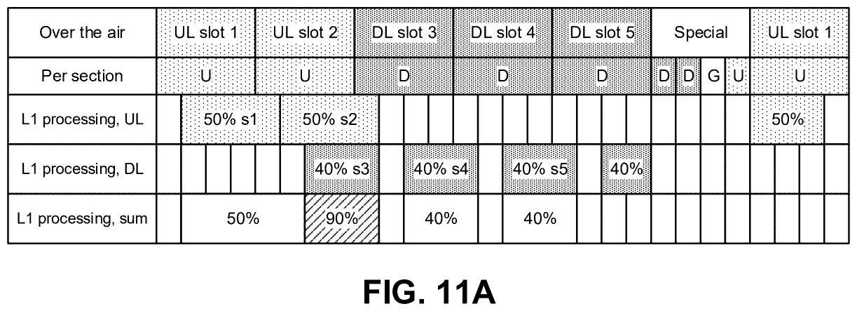

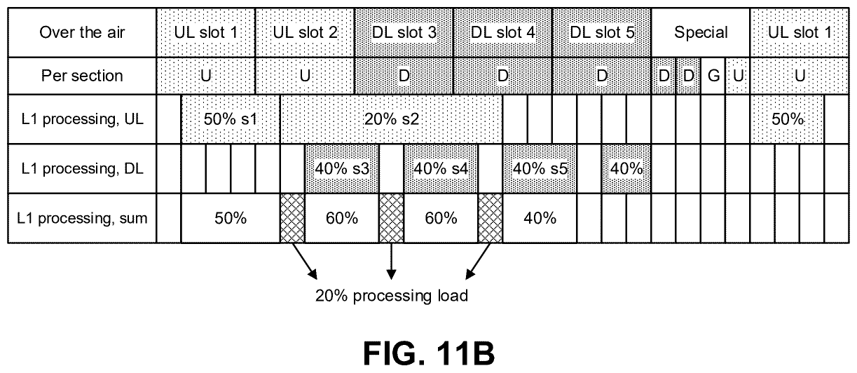

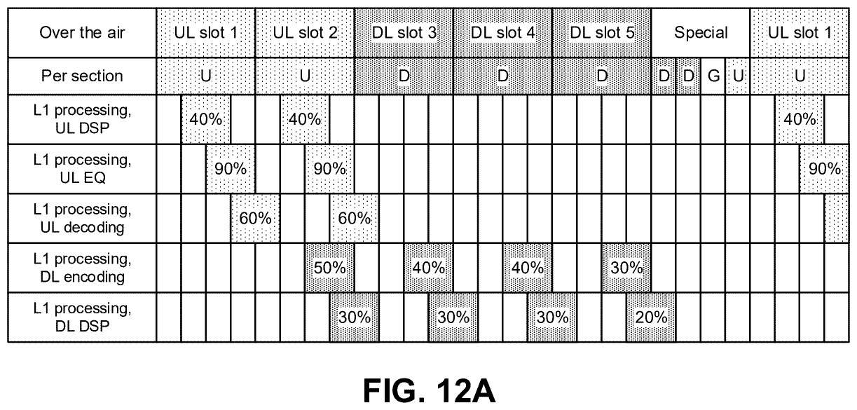

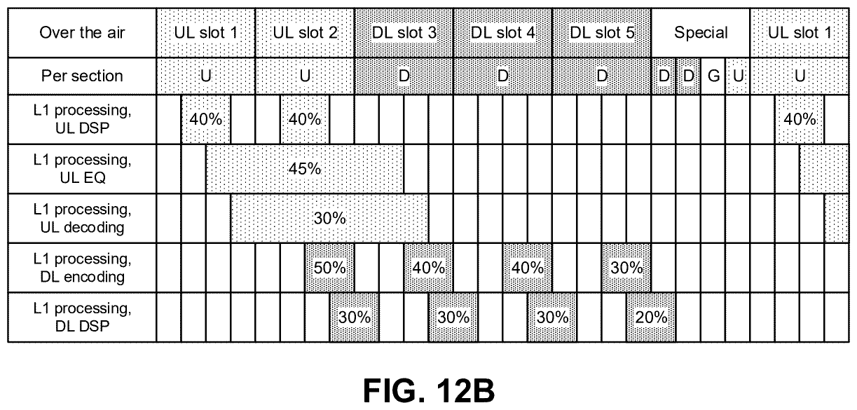

Turning next to FIGS. 11A, 11B, 12A, and 12B, respective examples for applying L1 overloading in respective L1 architectures are illustrated. Referring first to FIGS. 11A-B, example processing load for L1 equipment operating in a lookaside architecture (e.g., as described above with respect to FIG. 3) is shown. As shown in FIG. 11A, it is evident that additional UL processing (e.g., more cells, more features, more throughput, etc.) could be supported by L1 if some of the data packets of the UL slots could be processed during time conventionally reserved for DL slots, as shown in FIG. 11B. It is noted that L1 overloading as shown in FIG. 11B can reduce the peak processing load of the L1 equipment, here from a peak load of 90% to a peak load of 60%.

Referring next to FIGS. 12A-B, example processing load for L1 equipment operating in an inline architecture (e.g., as described above with respect to FIG. 4) is shown. In contrast to the lookaside architecture shown in FIGS. 11A-B, FIGS. 12A-B illustrate the processing load of respective accelerator components, such as those responsible for digital signal processing (DSP), equalization (EQ), and encoding/decoding data. From FIG. 12A, it can be seen that a particular accelerator component, here the UL EQ component, can be a bottleneck for increasing the number of supported cells, UL throughput, or algorithm complexity. Similar to the lookaside architecture represented by FIGS. 11A-B, FIG. 12B shows that by moving processing for some of the UL data packets to time conventionally reserved for DL slots, this limitation can be reduced.

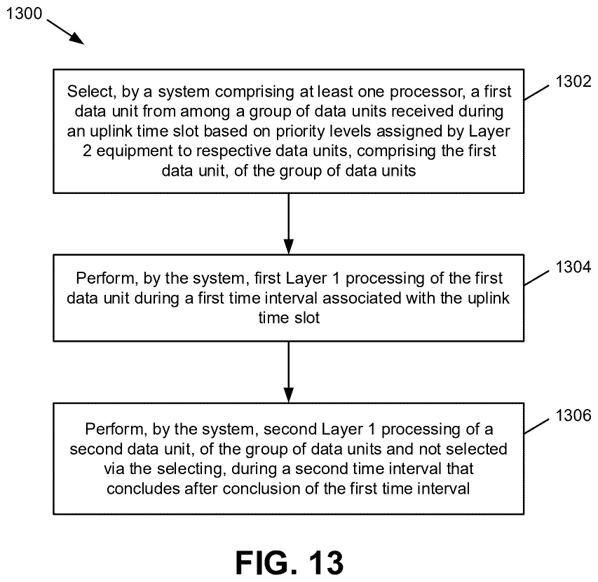

Referring now to FIG. 13, a flow diagram of a method 1300 that facilitates L1 overloading in TDD scenarios is illustrated. At 1302, a system comprising at least one processor can select (e.g., via a data prioritization module 110 of L1 equipment 10) a first data unit from among a group of data units received during an UL slot based on priority levels assigned by L2 equipment (e.g., L2 equipment 20) to respective data units, including the first data unit, of the group of data units.

At 1304, the system can perform (e.g., via an L1 processor 120 of the L1 equipment 10) first L1 processing of the first data unit during a first time interval (e.g., a priority window 122) associated with the UL slot.

At 1306, the system can perform (e.g., via the L1 processor 120) second L1 processing of a second data unit, of the group of data units and not selected at 1302, during a second time interval (e.g., an extended window 124) that concludes after conclusion of the first time interval.

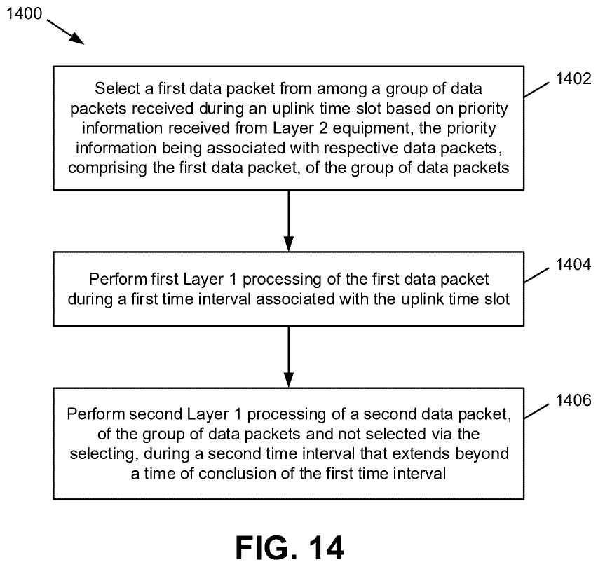

Referring next to FIG. 14, a flow diagram of a method 1400 that can be performed by at least one processor, e.g., based on machine-executable instructions stored on a non-transitory machine-readable medium, is illustrated. An example of a computer architecture, including a processor and non-transitory media, that can be utilized to implement method 1400 is described below with respect to FIG. 15.

Method 1400 can begin at 1402, in which the at least one processor can select a first data packet from among a group of data packets received during an UL time slot based on priority information received from L2 equipment. The priority information can be associated with respective data packets, comprising the first data packet, of the group of data packets.

At 1404, the at least one processor can perform first L1 processing of the first data packet during a first time interval associated with the UL time slot.

At 1406, the at least one processor can perform second L1 processing of a second data packet, of the group of data packets and not selected at 1402, during a second time interval that extends beyond a time of conclusion of the first time interval.

FIGS. 13-14 as described above illustrate methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

In order to provide additional context for various embodiments described herein, FIG. 15 and the following discussion are intended to provide a brief, general description of a suitable computing environment 1500 in which the various embodiments of the embodiment described herein can be implemented. While implementations have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference now to FIG. 15, an example general-purpose environment 1500 for implementing various embodiments described herein includes a computer 1502, the computer 1502 including a processing unit 1504, a system memory 1506 and a system bus 1508. The system bus 1508 couples system components including, but not limited to, the system memory 1506 to the processing unit 1504. The processing unit 1504 can be any of various commercially available processors. Dual microprocessors and other multi-processor architectures can also be employed as the processing unit 1504.

The system bus 1508 can be any of several types of bus structure that can further interconnect to a memory bus (with or without a memory controller), a peripheral bus, and a local bus using any of a variety of commercially available bus architectures. The system memory 1506 includes ROM 1510 and RAM 1512. A basic input/output system (BIOS) can be stored in a non-volatile memory such as ROM, erasable programmable read only memory (EPROM), EEPROM, which BIOS contains the basic routines that help to transfer information between elements within the computer 1502, such as during startup. The RAM 1512 can also include a high-speed RAM such as static RAM for caching data.

The computer 1502 further includes an internal hard disk drive (HDD) 1514 (e.g., EIDE, SATA), one or more external storage devices 1516 (e.g., a magnetic floppy disk drive (FDD), a memory stick or flash drive reader, a memory card reader, etc.) and an optical disk drive 1520 (e.g., which can read or write from a CD-ROM disc, a DVD, a BD, etc.). While the internal HDD 1514 is illustrated as located within the computer 1502, the internal HDD 1514 can also be configured for external use in a suitable chassis (not shown). Additionally, while not shown in environment 1500, a solid state drive (SSD) could be used in addition to, or in place of, an HDD 1514. The HDD 1514, external storage device(s) 1516 and optical disk drive 1520 can be connected to the system bus 1508 by an HDD interface 1524, an external storage interface 1526 and an optical drive interface 1528, respectively. The interface 1524 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1502, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1512, including an operating system 1530, one or more application programs 1532, other program modules 1534 and program data 1536. All or portions of the operating system, applications, modules, and/or data can also be cached in the RAM 1512. The systems and methods described herein can be implemented utilizing various commercially available operating systems or combinations of operating systems.

Computer 1502 can optionally comprise emulation technologies. For example, a hypervisor (not shown) or other intermediary can emulate a hardware environment for operating system 1530, and the emulated hardware can optionally be different from the hardware illustrated in FIG. 15. In such an embodiment, operating system 1530 can comprise one virtual machine (VM) of multiple VMs hosted at computer 1502. Furthermore, operating system 1530 can provide runtime environments, such as the Java runtime environment or the .NET framework, for applications 1532. Runtime environments are consistent execution environments that allow applications 1532 to run on any operating system that includes the runtime environment. Similarly, operating system 1530 can support containers, and applications 1532 can be in the form of containers, which are lightweight, standalone, executable packages of software that include, e.g., code, runtime, system tools, system libraries and settings for an application.

Further, computer 1502 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1502, e.g., applied at the application execution level or at the operating system (OS) kernel level, thereby enabling security at any level of code execution.

A user can enter commands and information into the computer 1502 through one or more wired/wireless input devices, e.g., a keyboard 1538, a touch screen 1540, and a pointing device, such as a mouse 1542. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1504 through an input device interface 1544 that can be coupled to the system bus 1508, but can be connected by other interfaces, such as a parallel port, an IEEE 1394 serial port, a game port, a USB port, an IR interface, a BLUETOOTH® interface, etc.

A monitor 1546 or other type of display device can be also connected to the system bus 1508 via an interface, such as a video adapter 1548. In addition to the monitor 1546, a computer typically includes other peripheral output devices (not shown), such as speakers, printers, etc.

The computer 1502 can operate in a networked environment using logical connections via wired and/or wireless communications to one or more remote computers, such as a remote computer(s) 1550. The remote computer(s) 1550 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1552 is illustrated. The logical connections depicted include wired/wireless connectivity to a local area network (LAN) 1554 and/or larger networks, e.g., a wide area network (WAN) 1556. Such LAN and WAN networking environments are commonplace in offices and companies, and facilitate enterprise-wide computer networks, such as intranets, all of which can connect to a global communications network, e.g., the Internet.

When used in a LAN networking environment, the computer 1502 can be connected to the local network 1554 through a wired and/or wireless communication network interface or adapter 1558. The adapter 1558 can facilitate wired or wireless communication to the LAN 1554, which can also include a wireless access point (AP) disposed thereon for communicating with the adapter 1558 in a wireless mode.

When used in a WAN networking environment, the computer 1502 can include a modem 1560 or can be connected to a communications server on the WAN 1556 via other means for establishing communications over the WAN 1556, such as by way of the Internet. The modem 1560, which can be internal or external and a wired or wireless device, can be connected to the system bus 1508 via the input device interface 1544. In a networked environment, program modules depicted relative to the computer 1502 or portions thereof, can be stored in the remote memory/storage device 1552. It will be appreciated that the network connections shown are example and other means of establishing a communications link between the computers can be used.

When used in either a LAN or WAN networking environment, the computer 1502 can access cloud storage systems or other network-based storage systems in addition to, or in place of, external storage devices 1516 as described above. Generally, a connection between the computer 1502 and a cloud storage system can be established over a LAN 1554 or WAN 1556 e.g., by the adapter 1558 or modem 1560, respectively. Upon connecting the computer 1502 to an associated cloud storage system, the external storage interface 1526 can, with the aid of the adapter 1558 and/or modem 1560, manage storage provided by the cloud storage system as it would other types of external storage. For instance, the external storage interface 1526 can be configured to provide access to cloud storage sources as if those sources were physically connected to the computer 1502.

The computer 1502 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
at least one processor; and
at least one memory that stores executable instructions that, when executed by the at least one processor, facilitate performance of operations, the operations comprising:
selecting a first data packet from among a group of data packets received during an uplink time slot based on priority indicators assigned by Layer 2 equipment to respective data packets, comprising the first data packet, of the group of data packets;
performing first Layer 1 processing of the first data packet during a first time window relative to the uplink time slot; and
performing second Layer 1 processing of a second data packet, of the group of data packets and not selected via the selecting, during a second time window that concludes after conclusion of the first time window.

2. The system of claim 1, wherein the priority indicators relate to quality of service classes associated with the respective data packets of the group of data packets.

3. The system of claim 1, wherein the priority indicators comprise binary values that schedule Layer 1 processing of the respective data packets of the group of data packets to a time window selected from a group comprising the first time window and the second time window.

4. The system of claim 1, wherein the uplink time slot is a first uplink time slot, and wherein the second time window extends into a second time slot that is after the first uplink time slot.

5. The system of claim 4, wherein:
the second time window has a first length in response to the second time slot being a second uplink time slot, and
the second time window has a second length in response to the second time slot being a downlink time slot, the second length being longer than the first length.

6. The system of claim 1, wherein the operations further comprise:
sending capacity information, representative of a first throughput capacity of the first Layer 1 processing in the first time window and a second throughput capacity of the second Layer 1 processing in the second time window, to the Layer 2 equipment, wherein the Layer 2 equipment assigns the priority indicators to the respective data packets of the group of data packets in response to receiving the capacity information.

7. The system of claim 1, wherein the operations further comprise:
determining a number of data packets, comprising the first data packet, of the group of data packets that is scheduled for the first Layer 1 processing during the first time window; and
in response to the number of data packets exceeding a data packet capacity for the first time window, sending an error message to the Layer 2 equipment.

8. The system of claim 1, wherein the operations further comprise:
communicating first processed data, resulting from the first Layer 1 processing of the first data packet, to the Layer 2 equipment upon conclusion of the first time window; and
communicating second processed data, resulting from the second Layer 1 processing of the second data packet, to the Layer 2 equipment upon conclusion of the second time window.

9. The system of claim 1, wherein the operations further comprise:
receiving, from the Layer 2 equipment, an instruction to enable the second Layer 1 processing during the second time window, wherein the performing of the second Layer 1 processing is in response to the receiving of the instruction.

10. A method, comprising:
selecting, by a system comprising at least one processor, a first data unit from among a group of data units received during an uplink time slot based on priority levels assigned by Layer 2 equipment to respective data units, comprising the first data unit, of the group of data units;
performing, by the system, first Layer 1 processing of the first data unit during a first time interval associated with the uplink time slot; and
performing, by the system, second Layer 1 processing of a second data unit, of the group of data units and not selected via the selecting, during a second time interval that concludes after conclusion of the first time interval.

11. The method of claim 10, wherein the priority levels correspond to quality of service classes associated with the respective data units of the group of data units.

12. The method of claim 10, wherein the uplink time slot is a first uplink time slot, and wherein the second time interval extends into a second time slot that is after the first uplink time slot.

13. The method of claim 12, wherein:
the second time interval has a first length based on the second time slot being a second uplink time slot, and
the second time interval has a second length based on the second time slot being a downlink time slot, the second length being longer than the first length.

14. The method of claim 10, further comprising:
determining, by the system, a number of data units, comprising the first data unit, of the group of data units that is scheduled for the first Layer 1 processing during the first time interval; and
sending, by the system, an error message to the Layer 2 equipment in response to the number of data units exceeding a threshold number of data units.

15. The method of claim 10, further comprising:
sending, by the system, first processed data, resulting from the first Layer 1 processing of the first data unit, to the Layer 2 equipment in response to the first time interval having concluded; and
sending, by the system, second processed data, resulting from the second Layer 1 processing of the second data unit, to the Layer 2 equipment in response to the second time interval having concluded.

16. A non-transitory machine-readable medium comprising computer executable instructions that, when executed by at least one processor, facilitate performance of operations, the operations comprising:
selecting a first data packet from among a group of data packets received during an uplink time slot based on priority information received from Layer 2 equipment, the priority information being associated with respective data packets, comprising the first data packet, of the group of data packets;
performing first Layer 1 processing of the first data packet during a first time interval associated with the uplink time slot; and
performing second Layer 1 processing of a second data packet, of the group of data packets and not selected via the selecting, during a second time interval that extends beyond a time of conclusion of the first time interval.

17. The non-transitory machine-readable medium of claim 16, wherein the uplink time slot is a first uplink time slot, and wherein the second time interval extends into a second time slot that is after the first uplink time slot.

18. The non-transitory machine-readable medium of claim 17, wherein:
where the second time slot is a second uplink time slot, the second time interval has a first length, and
where the second time slot is a downlink time slot, the second time interval has a second length longer than the first length.

19. The non-transitory machine-readable medium of claim 16, wherein the operations further comprise:
determining a number of data packets, comprising the first data packet, of the group of data packets that is scheduled for the first Layer 1 processing during the first time interval; and
sending an error message to the Layer 2 equipment in response to the number of data packets being determined to exceed a threshold number of data packets.

20. The non-transitory machine-readable medium of claim 16, wherein the operations further comprise:
in response to the first time interval expiring, sending first processed data, resulting from the first Layer 1 processing of the first data packet, to the Layer 2 equipment; and
in response to the second time interval expiring, sending second processed data, resulting from the second Layer 1 processing of the second data packet, to the Layer 2 equipment.
